(19) United States
(12) Patent Application Publication
(10) Pub. No.: US 2008/0084045 A1
(43) Pub. Date: Apr. 10, 2008

(54) Platform channel lock for running boards

(76) Inventors: Dino Filias, Sterling Heights, MI (US); Christopher J. Kuntze, Clarkston, MI (US); Rob Dargel, Rochester, MI (US); Jason Hepner, Davisburg, MI (US); James W. Shelswell, Barrie (CA)

Correspondence Address: CLARK HILL, P.C., 500 WOODWARD AVENUE, SUITE 3500, DETROIT, MI, 48226, US

(21) Appl. No.: 11/542,870

(22) Filed: Oct. 4, 2006

(51) Int. Cl. B60R 3/00

(52) U.S. Cl. 280/166

(57) ABSTRACT

A running board assembly for a motor vehicle includes a mounting bracket adapted to be fixedly secured thereto. The running board assembly also includes at least one arm pivotally secured to the mounting bracket. A link includes an inner end pivotally secured to the at least one arm and an opposing outer end. The link includes at least one tongue extending out from the outer end and at least one outwardly extending wing. A platform defines a groove for receiving the at least one tongue therewithin to form an interlock and includes a lower channel abutting the at least one outwardly extending wing in a closed box configuration to provide a rigid attachment between the platform and the link.

### BACKGROUND OF THE INVENTION

1. Field of the Invention

The invention relates to a running board assembly for a motor vehicle. More particularly, the invention relates to an interlock including a tongue and groove for maintaining a tight, rigid attachment between a link and a platform of a running board assembly.

2. Description of Related Art

Running boards are well-known for assisting individuals in entering and exiting motor vehicles having a high ground clearance. Retractable running boards include a platform or step that is movable between a retracted position, in which the platform is tucked underneath a motor vehicle body panel, and an extended position, in which the platform is spaced apart from the motor vehicle body panel for supporting an individual. Typically, a four bar linkage is utilized to effectuate movement of the platform between the retracted and extended positions. The four bar linkage includes a mounting bracket adapted to be fixedly secured to the motor vehicle body panel, a link fixedly secured to the platform, and a pair of arms pivotally interconnected between the mounting bracket and the link.

A common problem in such retractable running board assemblies is an inadequate attachment between the platform and the link. The result of this inadequate attachment is movement of the platform relative to the link. It would be desirable to eliminate the relative movement between the platform and the link.

### SUMMARY OF THE INVENTION

According to one aspect of the invention, a running board assembly for a motor vehicle includes a mounting bracket adapted to be fixedly secured thereto. At least one arm is pivotally coupled to the mounting bracket. A link includes an inner end pivotally coupled to the at least one arm and an opposing outer end. The link includes at least one tongue extending out from the outer end and at least one outwardly extending wing. A platform defines a groove for receiving the at least one tongue therewithin to form an interlock and includes a lower channel abutting the at least one outwardly extending wing in a closed box configuration to provide a rigid attachment between the platform and the link.

### BRIEF DESCRIPTION OF THE DRAWINGS

The invention will be readily appreciated as the same becomes better understood by reference to the following detailed description when considered in connection with the accompanying drawings wherein:

FIG. 1 is a perspective view of a running board assembly according to the invention including a platform in an extended position;

FIG. 2 is a perspective view of the running board assembly including the platform in a retracted position;

FIG. 3 is a cross-sectional view of the platform taken along line 3-3 in FIG. 1;

FIG. 4 is a rear, perspective view of the platform, partially cut away, and a link fixedly secured thereto;

FIG. 5 is an exploded, perspective view of the platform and the link in FIG. 4;

FIG. 6 is an exploded, perspective view of the link including a pair of spaced apart tongues extending out from an outer end;

FIG. 7 is a perspective view of the link including a single, elongated tongue extending out from the outer end;

FIG. 8A is a cross-sectional view, partially cut away, taken along line 8A-8A in FIG. 9;

FIG. 8B is a cross-sectional view, partially cut away, taken along line 8B-8B in FIG. 9;

FIG. 9 is a perspective view of the platform, partially cut away, including upper and lower channels, and the link;

FIG. 10 is an exploded, perspective view of the platform in FIG. 9 including the upper and lower channels each receiving a nut, and the link including wings for engaging the lower channels; and

FIG. 11 is an exploded, perspective view of the link including two spaced apart wings.

### DETAILED DESCRIPTION OF THE PREFERRED EMBODIMENT

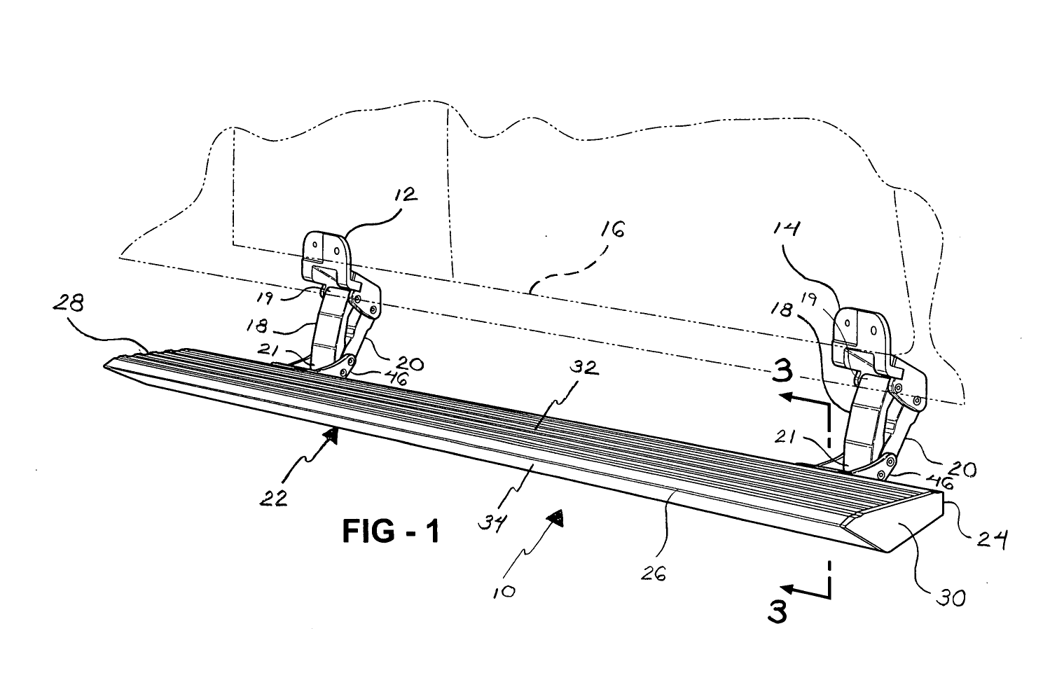

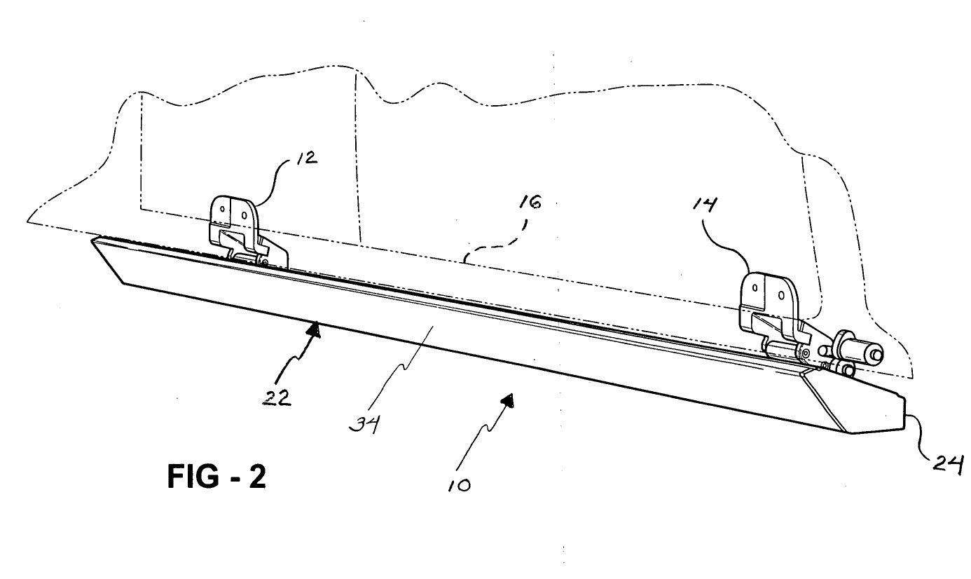

Referring to FIGS. 1 and 2, a running board assembly, generally shown at 10, includes a pair of spaced apart mounting brackets 12, 14 adapted to be fixedly secured to an underbody 16 of a motor vehicle. It is appreciated that although two mounting brackets 12, 14 are shown, the number of mounting brackets utilized in the running board assembly 10 may vary. First 18 and second 20 arms are pivotally secured to each mounting bracket 12, 14. Each of the first 18 and second 20 arms extends between opposing first 19 and second 21 ends.

The running board assembly 10 also includes a platform or step, generally indicated at 22, operably coupled to the first 18 and second 20 arms of each mounting bracket 12, 14 for movement between an extended position, shown in FIG. 1, and a retracted position, shown in FIG. 2. In a preferred embodiment, the platform 22 is elongated. It is, however, appreciated that the size of the platform 22 may vary.

The platform 22 includes an inboard surface 24 and an outboard edge 26 each extending longitudinally between a pair of spaced apart end walls 28, 30. A stepping surface 32 of the platform 22 extends longitudinally between the pair of spaced apart end walls 28, 30, and laterally between the inboard surface 24 and the outboard edge 26. When the platform 22 is in the extended position, as shown in FIG. 1, the stepping surface 32 is available to support individuals entering, exiting, or otherwise accessing the motor vehicle. A bottom surface 34 of the platform 22 also extends longitudinally between the pair of spaced apart end walls 28, 30 and laterally between the inboard surface 24 and the outboard edge 26. The bottom surface 34 is visible from outside the motor vehicle when the platform 22 is in the retracted position, as shown in FIG. 2.

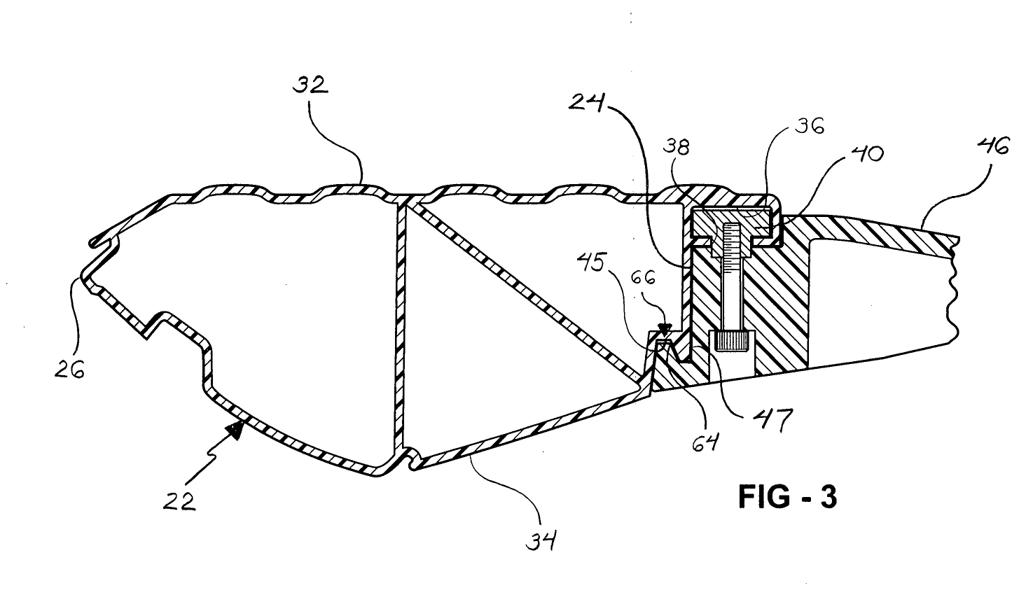

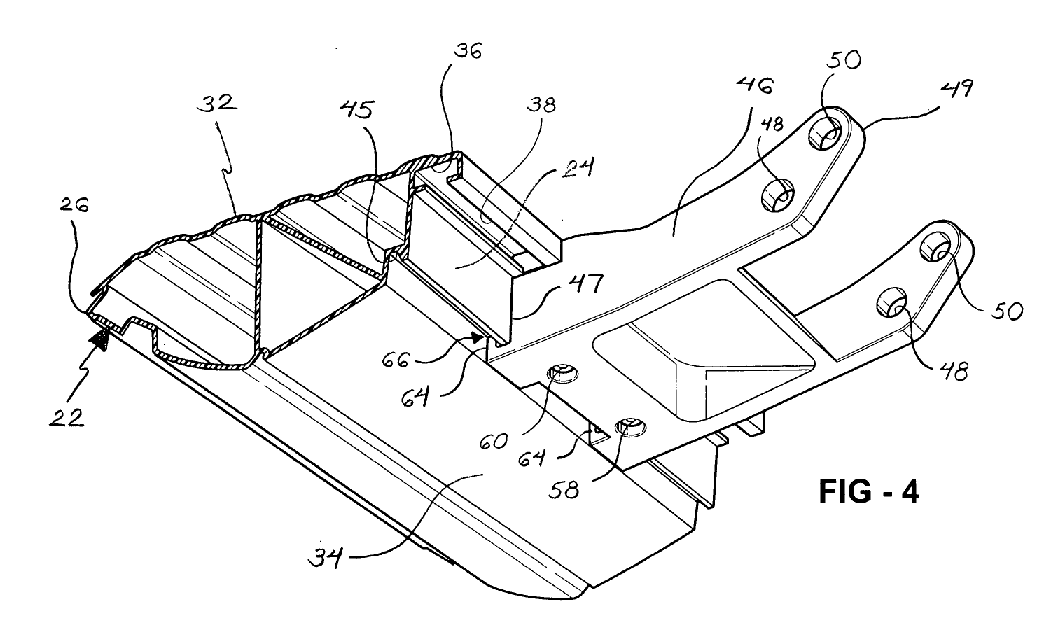

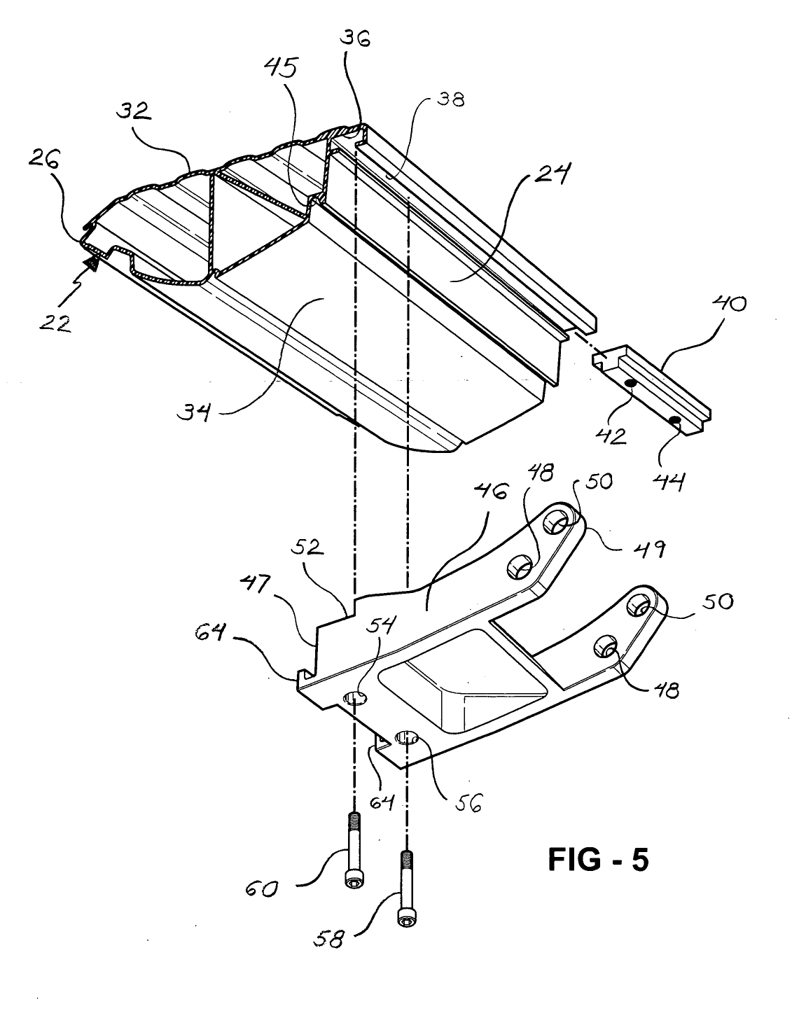

Referring to FIGS. 3 through 5, the platform 22 includes an upper channel 36 formed adjacent the inboard surface 24. The upper channel 36 is oriented generally horizontally and includes a lower opening 38. Preferably, the upper channel 36 extends longitudinally along the platform 22 between the end walls 28, 30 thereof. It is, however, appreciated that the length of the upper channel 36 may vary.

A nut 40 is positioned within the upper channel 36 and is fixedly secured therewithin. The nut 40 is preferably T-shaped. The nut 40 includes a pair of threaded openings 42, 44. When the nut 40 is fixedly mounted within the upper channel 36, the pair of threaded openings 42, 44 is accessible through the lower opening 38 in the upper channel 36.

The platform 22 also includes a groove 45 located between the inboard surface 24 and the bottom surface 34. In a preferred embodiment, the groove 45 extends longitudinally along the platform 22 between the end walls 28, 30 thereof. It is, however, appreciated that both the location and the length of the groove 45 may vary.

Referring to FIGS. 3 through 7, a link 46 includes an outer end 47 fixedly secured to the platform 22 and an inner end 49 pivotally secured to the first 18 and second 20 arms corresponding with each mounting bracket 12, 14 (see FIG. 1). The inner end 49 of each link 46 is pivotally secured to the lower end 21 of each of the first 18 and second 20 arms via pivot pins extending through pivot apertures 48, 50. Each link 46 includes a pair of apertures 54, 56 adjacent the outer end 47. Each of the pair of apertures 54, 56 extends completely through the link 46. A pair of fasteners 58, 60 extends through the respective pair of apertures 54, 56 in the link 46 and the corresponding pair of threaded openings 42, 44 in the nut 40 positioned in the upper channel 36 to fixedly secure the link 46 to the platform 22.

The outer end 47 of the link 46 is adapted to abut the inboard surface 24 of the platform 22. In order to provide a more rigid connection between the link 46 and the platform 22, the link 46 includes at least one tongue 64 extending out from the outer end 47. The at least one tongue 64 is received within the groove 45 formed along the platform 22 to form an interlock, generally indicated at 66, as the fasteners 58, 60 are tightened into place. The interlock 66 is an interference fit between the at least one tongue 64 and the groove 45. The interference fit between the at least one tongue 64 and the groove 45 provides a tight, rigid attachment between the link 46 and the platform 22.

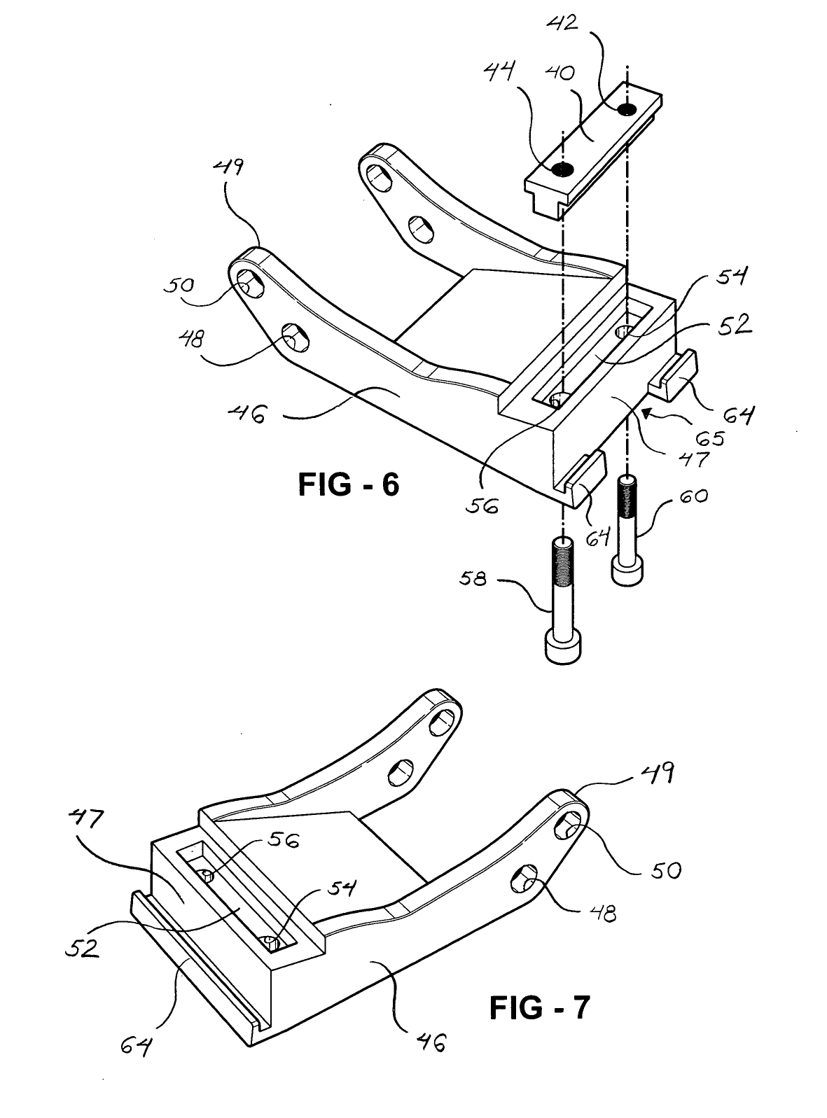

Preferably, the link 46 includes two spaced apart tongues 64 each extending out from the outer end 47 and defining a gap 65 therebetween, as shown in FIG. 6. As an alternative, the link 46 may include a single elongated tongue 64, as shown in FIG. 7, thereby eliminating the gap 65. It is contemplated that the particular number of tongues 64 may vary.

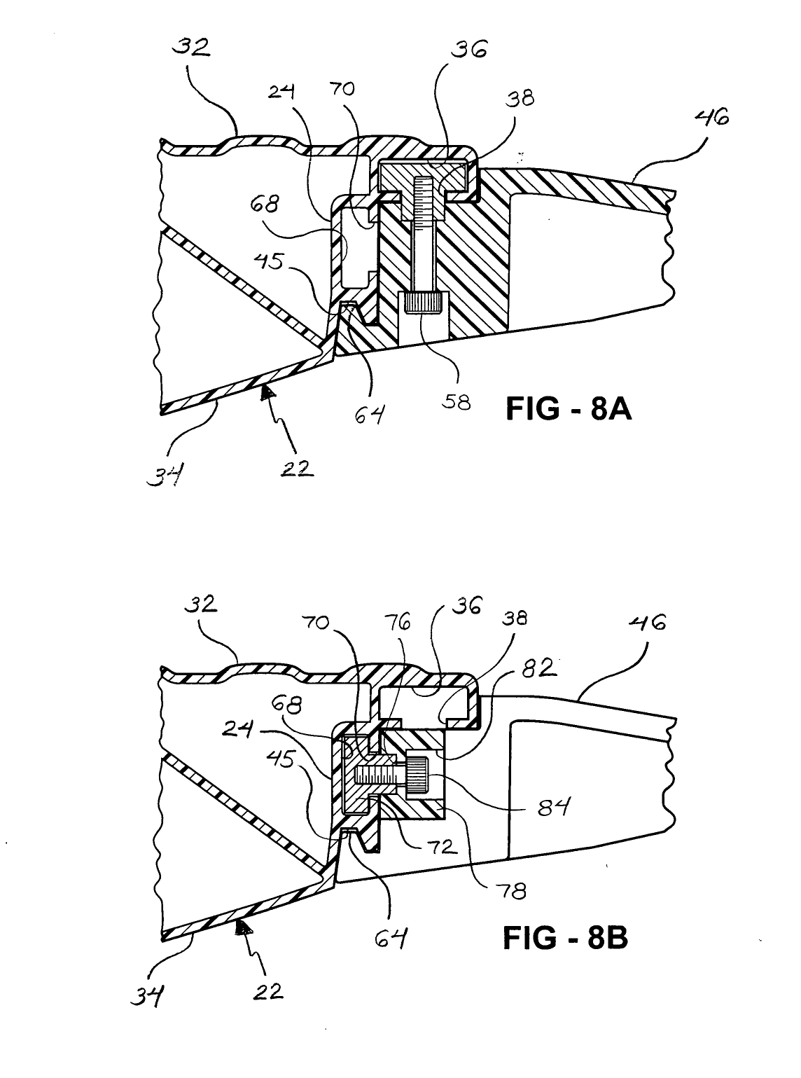

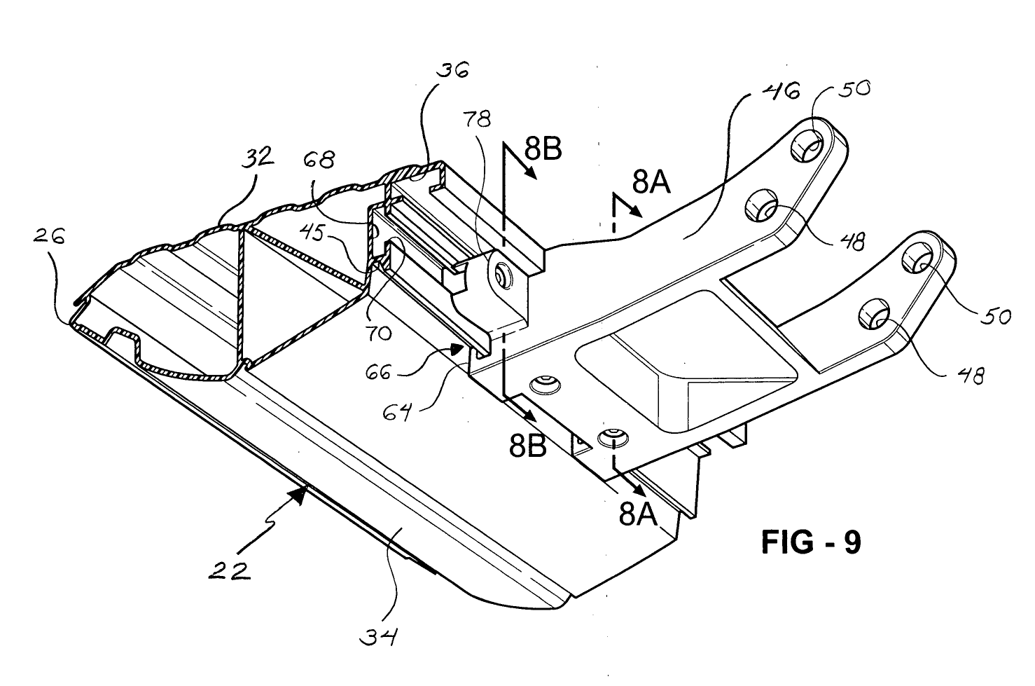

Referring to FIGS. 8A, 8B, and 9, the platform 22 may be formed with both the upper channel 36 and a lower channel 68. The lower channel 68 is oriented generally vertically and is positioned along the inboard surface 24 of the platform 22 directly above the groove 45. The lower channel 68 defines an opening 70.

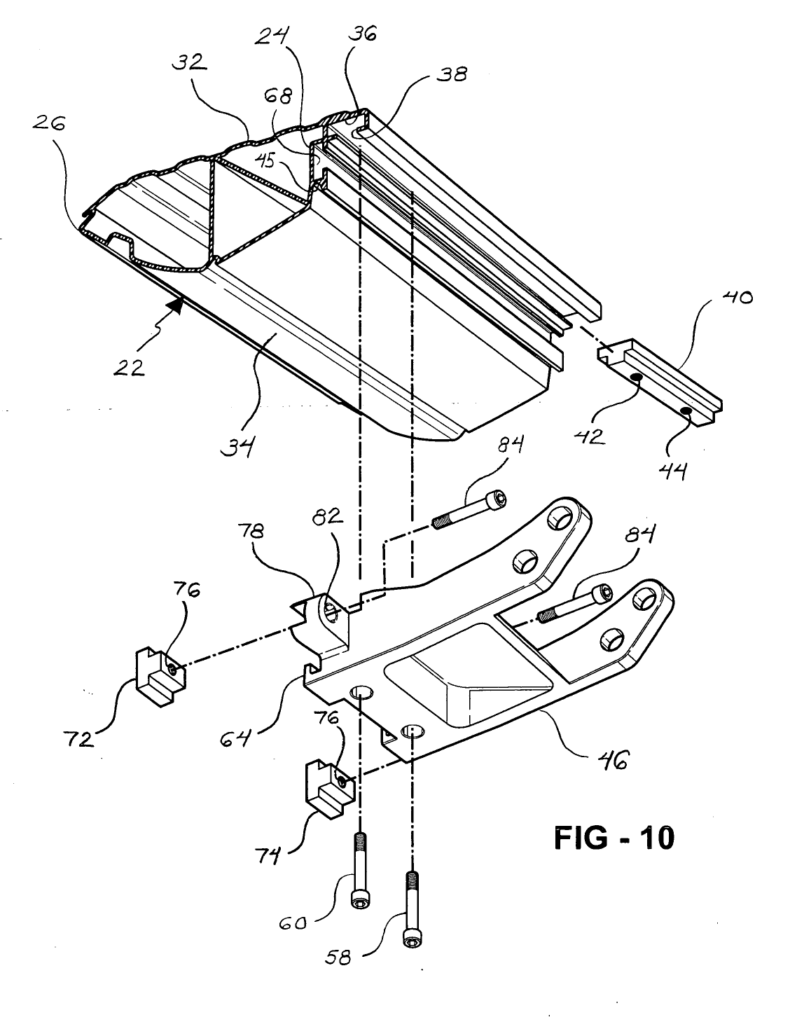

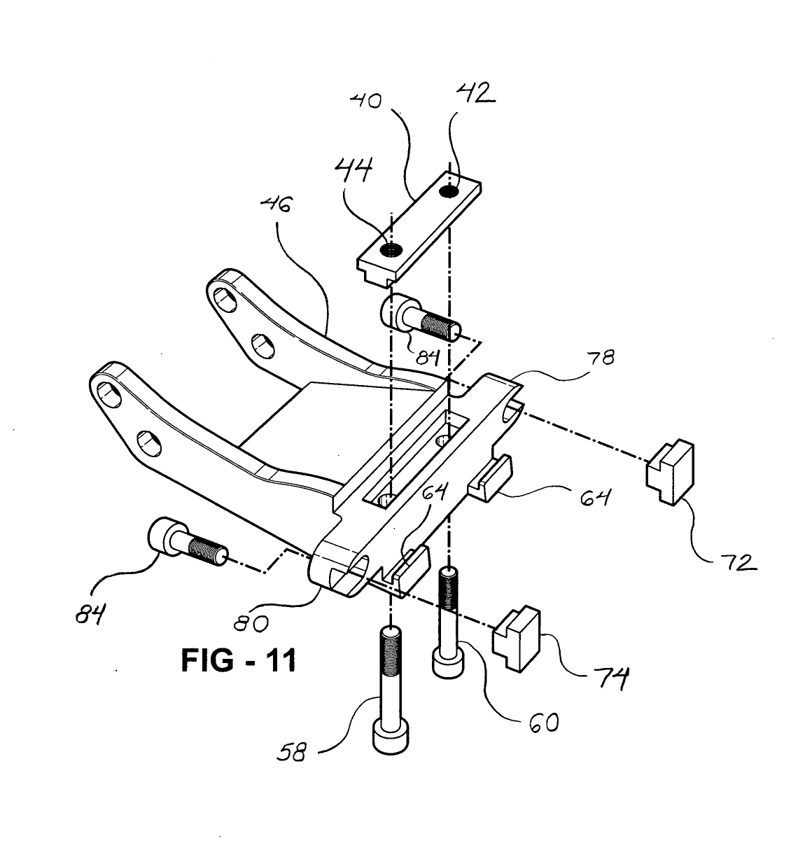

Referring to FIGS. 10 and 1, two spaced apart nuts 72, 74 are disposed within the lower channel 68 and partially extend into the opening 70. Each nut 72, 74 is generally T-shaped. The nuts 72, 74 include a threaded opening 76 extending therethrough.

In order to provide an even more rigid attachment between the platform 22, having the upper 36 and lower 68 channels, and the link 46, the link 46 includes a pair of outwardly extending wings 78, 80 spaced apart from one another. Each of the wings 78, 80 includes an aperture 82 that is aligned with the threaded opening 76 formed in the nuts 72, 74. A fastener 84 extends through one of the apertures 82 and the corresponding threaded opening 76 to further immobilize the attachment between the platform 22 and the link 46. When the fastener 84 is fixed into place, a box-like configuration is formed at the interface between each wing 78, 80 and the lower channel 68. The box-like configuration provides further rigidity to the attachment between the platform 22 and the link 46.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A running board assembly for a motor vehicle, said running board assembly comprising:
a mounting bracket adapted to be fixedly secured to the motor vehicle;
at least one arm pivotally secured to said mounting bracket;
a link having an inner end pivotally secured to said at least one arm and an opposing outer end, said link including at least one tongue extending out from said outer end and having at least one outwardly extending wing; and
a platform defining a groove for receiving said at least one tongue therewithin to form an interlock and including a lower channel abutting said at least one outwardly extending wing in a closed box configuration to provide a rigid attachment between said platform and said link.

2. A running board assembly as set forth in claim 1 including a fastener extending through said at least one outwardly extending wing and a portion of said lower channel to fixedly secure said link to said platform.

3. A running board assembly as set forth in claim 2 including at least one nut disposed within said lower channel for threaded engagement with said fastener.

4. A running board assembly as set forth in claim 3 wherein said at least one wing includes an aperture extending therethrough for receiving said fastener.

5. A running board assembly as set forth in claim 4 wherein said nut includes a threaded opening adapted to be aligned with said aperture in said at least one wing.

6. A running board assembly as set forth in claim 1 wherein said platform includes an upper channel.

7. A running board assembly as set forth in claim 6 including a fastener extending through a portion of said link and a portion of said upper channel to fixedly secure said link to said platform.

8. A running board assembly as set forth in claim 7 including a nut disposed within said upper channel.

9. A running board assembly as set forth in claim 8 wherein said link includes an aperture extending therethrough for receiving said fastener.

10. A running board assembly for a motor vehicle, said running board assembly comprising:
a mounting bracket adapted to be fixedly secured to the motor vehicle;
at least one arm pivotally coupled to said mounting bracket;
a link having an inner end pivotally coupled to said at least one arm and an opposing outer end, said outer end having at least one tongue extending out therefrom; and
a platform having a groove receiving said at least one tongue therewithin to form an interlock providing a tight, rigid attachment between said platform and said link.

11. A running board assembly as set forth in claim 10 including at least one fastener for fixedly securing said link to said platform.

12. A running board assembly as set forth in claim 11 wherein said platform includes an inboard surface adapted to abut said outer end of said link when said tongue is received within said groove.

13. A running board assembly as set forth in claim 10 wherein said platform includes an upper channel.

14. A running board assembly as set forth in claim 13 including a fastener extending through a portion of said link and a portion of said upper channel to fixedly secure said link to said platform.

15. A running board assembly as set forth in claim 14 including a nut disposed within said upper channel.

16. A running board assembly as set forth in claim 15 wherein said link includes an aperture extending therethrough for receiving said fastener.

17. A running board assembly for a motor vehicle, said running board assembly comprising:
a mounting bracket adapted to be fixedly secured to the motor vehicle;
at least one arm pivotally coupled to said mounting bracket;
a link having an inner end pivotally coupled to said at least one arm and an opposing outer end, said link having at least one wing extending out from said outer end; and
a platform fixedly secured to said link, said platform including an inboard end defining a lower channel adapted to abut said at least one wing in a closed box configuration to provide a tight, rigid attachment between said link and said platform.

18. A running board assembly as set forth in claim 17 including a fastener extending through said at least one wing and a portion of said lower channel to fixedly secure said link to said platform.

19. A running board assembly as set forth in claim 18 including a nut disposed within said lower channel.

20. A running board assembly as set forth in claim 19 wherein said nut includes a threaded opening.

21. A running board assembly as set forth in claim 20 wherein said at least one wing includes an aperture extending therethrough.

22. A running board assembly as set forth in claim 17 wherein said platform includes an upper channel.

23. A running board assembly as set forth in claim 22 including a fastener extending through a portion of said link and a portion of said upper channel to fixedly secure said link to said platform.
